(19) United States
(12) Patent Application Publication
(10) Pub. No.: US 2005/0009470 A1
(43) Pub. Date: Jan. 13, 2005

(54) Remote control method in mobile communication terminal

(76) Inventor: Min-Ha Kim, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,743

(22) Filed: Dec. 30, 2003

(30) Foreign Application Priority Data
Jul. 10, 2003 (KR) 2003-46631

(51) Int. Cl. H04M 3/00

(52) U.S. Cl. 455/41.2; 455/41.3; 455/420

(57) ABSTRACT

A method for remotely-controlling a mobile communication terminal is disclosed. The method includes the steps of: a) determining whether an address of a remote mobile communication terminal is included in a list of short-range mobile communication address; b) if the address of the remote mobile communication terminal is included in the list, controlling the remote mobile communication terminal according to a remote control signal by establishing a communication link with the remote mobile communication terminal from a short distance using a Bluetooth protocol, authorizing a remote control; and c) if not, controlling the remote mobile communication terminal by establishing a call connection with the remote mobile communication terminal and authorizing a remote control.

### FIELD OF THE INVENTION

The present invention relates to a remote control method in a mobile communication terminal; and, more particularly, to a method for remotely controlling a mobile communication terminal from a long distance or a short distance by establishing a mobile communication call connection or using Bluetooth technology to the mobile communication terminal, respectively, after an authentication procedure

### DESCRIPTION OF RELATED ART

Hereinafter, a mobile communication terminal referred to all portable terminals capable of wireless communication, such as a mobile communication terminal, Personal Communication Services (PCS) terminal, Personal Digital Assistant (PDA), smart phone, next generation mobile telecommunication (IMT-2000) terminal and terminal capable of wireless LAN. The mobile communication terminal will be quoted as a working example in the following description of the preferred embodiments of the present invention.

Bluetooth wireless technology is a standard technology specification for establishing a wireless communication in a short range such as 10 to 100 meters between mobile communication terminal and personal computers, other portable devices, or peripherals and Network-access-points. Bluetooth technology is cost-effective and has low power consumption about 100 mW.

Bluetooth wireless technology introduced in 1997 at Ericsson research laboratories as a research project on the wireless interface between cellular phone and peripherals with the aim of replacing typical wired connection using cables with the wireless interface. Bluetooth wireless technology now turns into a multi-million dollar industry with a wide variety of application fields. The application fields of Bluetooth wireless technology come in a many varieties as basic commodities, like a cellular phone, Personal Computer (PC), Personal Digital Assistant (PDA), wireless headphone set and television. Nowadays, mobile communication terminals with Bluetooth wireless technology are under active development and increasingly commonplace. Based on a report released by Korean Internet Data Center (IDC Korea), in the year 2006, about 70 percent of the total number of mobile communication terminals will have Bluetooth wireless technology on board.

On the other hand, as mobile communication terminals currently on the market come with a wide variety of functions, the type of data stored in the terminals ranges from picture to multimedia image. When a user wants to share such data with friends or family members, the user has to manually select proper communication means among several available communication means after considering the circumstance including the distance to the mobile communication terminal of the friend or family member. Therefore, the above mentioned conventional method of sharing data is a passive type sharing method.

However, if the user can automatically access and upload/download desired data to/from the mobile communication terminal of the friends or family member without considering of the circumstance, it would be very convenient.

For instance, if a user does not know the distance between location of his cell phone and location of himself, the user has to access the cell phone through an expensive commercial mobile communication service although the distance is short enough to access through Bluetooth network when a user needs to access an electronic address book stored in his cell phone left remote location.

### SUMMARY OF THE INVENTION

It is, therefore, an object of the present invention to provide a method for detecting the distance between a master mobile communication terminal and the slave mobile communication terminal.

It is another object of the present invention to provide a method for remotely controlling a mobile communication terminal from a long distance by establishing a mobile communication call connection to the mobile communication terminal at a remote site after an authentication procedure.

It is another object of the present invention to provide a method for remotely controlling a mobile communication terminal from a short distance by using Bluetooth technology after an authentication procedure without making the mobile communication call connection with the terminal.

It is still another object of the present invention to provide a method for remotely controlling a mobile communication terminal in a remote site from another mobile communication terminal in long distance away by establishing a mobile communication call connection after the authentication procedure and remotely controlling a mobile communication terminal in a remote site from anther mobile communication terminal in a short distance away by using Bluetooth technology after the authentication procedure without establishing the mobile communication call connection.

In accordance with an aspect of the present invention, there is provided a method for remotely controlling a mobile communication terminal from a distance, the method including the steps of: a) determining whether an address of a remote mobile communication terminal is included in a list of short-range mobile communication address or not according to a remote control request signal; b) if the address of the remote mobile communication terminal is included in the list of short-range mobile communication address, controlling the remote mobile communication terminal according to a remote control signal inputted through an input unit by establishing a communication link with the remote mobile communication terminal from a short distance using a Bluetooth protocol according to a remote control request signal, authorizing a remote control of a remote wireless communication terminal; and c) if the address of the remote mobile communication terminal is not included in the list of short-range mobile communication address, controlling the remote mobile communication terminal according to a remote control signal inputted through an input unit by establishing a call connection between the mobile communication terminal and the remote mobile communication terminal according to a remote control request signal and authorizing a remote control of the remote mobile communication terminal.

In accordance with another aspect of the present invention, there is provided a mobile communication terminal for remotely controlling other mobile communication terminal, including: a memory for storing a list of short-range mobile communication address; a controller for determining or not whether an address of a remote mobile communication terminal is included in the list of short-range mobile communication address according to a remote control request signal; a mobile communication transceiver for communicating a remote mobile communication terminal through a mobile communication network by establishing a call connection with the remote mobile communication terminal according to the remote control request signal and authorizing a remote control of the remote mobile communication terminal when a result of the determination of the controller is that the address of a remote mobile communication terminal is not included in the list of short-range mobile communication address; a Bluetooth communication transceiver for communicating a remote mobile communication terminal through Bluetooth communication by establishing a communication link with the remote mobile communication terminal and authorizing the remote control of the remote communication mobile terminal when a result of determination of the controller is that the address of the remote mobile communication terminal is not included in the list of short-range mobile communication address.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a mobile communication terminal in accordance with a preferred embodiment of the present invention;

FIG. 2 is a flowchart showing a method for controlling a mobile communication terminal from a long distance in accordance with an embodiment of the present invention; and

FIG. 3 is a flow chart showing the connections between the different stages of a method for controlling the operation of a mobile communication terminal from a short distance in accordance with another embodiment of the present invention.

### DETAILED DESCRIPTION OF THE INVENTION

Other objects and aspects of the invention will become apparent from the following description of the embodiments with reference to the accompanying drawings, which is set forth hereinafter.

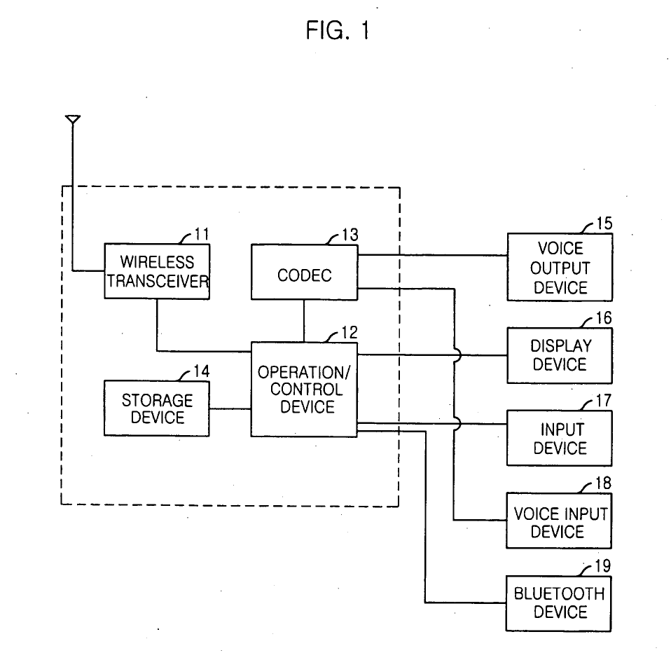

FIG. 1 is a block diagram illustrating a mobile communication terminal in accordance with a preferred embodiment of the present invention.

Referring to FIG. 1, the mobile communication terminal includes a wireless transceiver 11, an operation/control device 12, a CODEC 13, a storage device 14, a voice output device 15, e.g., a speaker, a display device 16, e.g., a Liquid Crystal Display (LCD), an input device 17, e.g., a keypad, a voice input device 18, e.g., a microphone, and a Bluetooth device 19.

The wireless transceiver 11 receives and transmits signals through an antenna. The operation/control device 12 controls the operation of the mobile communication terminal either from a long distance via a mobile communication call connection made with the terminal after an authentication procedure or from a short distance via an authentication procedure using Bluetooth wireless technology without making the mobile communication call connection with the terminal. The CODEC 13 transforms electrical signals received from the wireless transceiver 11 into voices that can be heard through the voice output device 15 such as a speaker according to the instructions given by the operation/control device 12. Also, the CODEC 13 transforms voices received through the voice input device 18 into electrical signals which is to be passed trough the operation/control device 12 and, in turn, to be transmitted from the wireless transceiver 11. The storage device 14 stores software programs to perform remote control functions, file systems containing image, character and icon, and the operating system. The voice output device 15 such as a speaker is a device for transforming electrical signals to voice via the CODEC 13. The display device 16 is a device for displaying words and pictures are shown according to the instructions given by the operation/control device 12. The input device 17, e.g., a keypad, is a device for inputting information such as telephone numbers, menu options, remote control request signals and remote control signals. The voice input device 18, e.g., a microphone, receives voice data and, in turn, sends the voice data to the CODEC 13. The Bluetooth device 19 receives and transmits Bluetooth signals based on the instructions given by the operation/control device 12.

Here, the operation/control device 12 further performs a task for receiving a remote control signal from other mobile communication terminals, performing operations according to the received remote control signal and transmitting the response back to other mobile communication terminals. As described below in accordance with an embodiment of the present invention, the above-mentioned routine is the equivalent to the feedback procedure of other mobile communication terminals at a long or short distance.

Furthermore, a typical feature of the mobile communication terminal is that a remote mobile communication terminal is controlled from a long distance by establishing a mobile communication call connection between the mobile communication terminal and the remote mobile communication terminal through an authentication procedure. In addition, another typical feature of the mobile communication terminal is that a remote mobile communication terminal is controlled from a short distance by using Bluetooth technology without making the mobile communication call connection with the terminal through an authentication procedure.

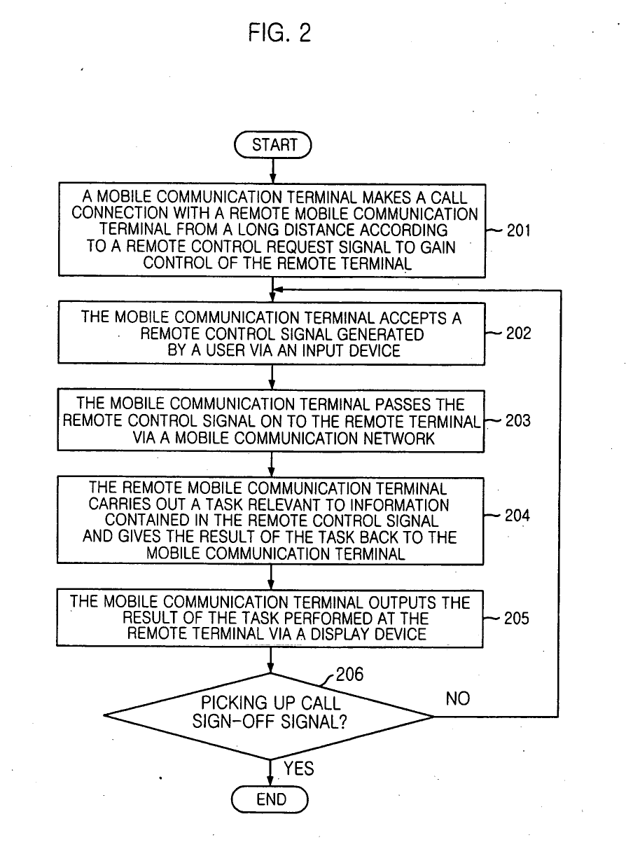

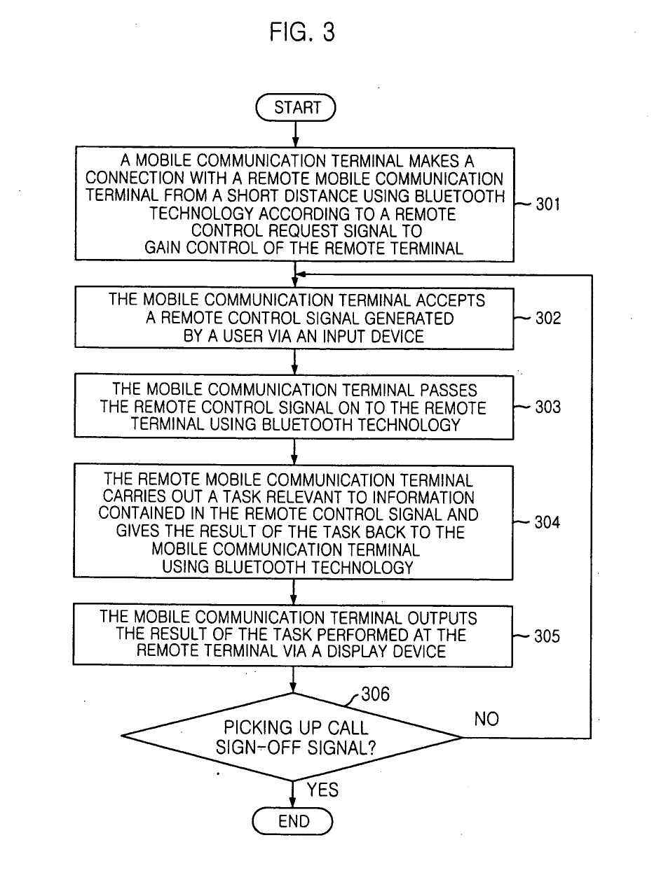

In accordance with an embodiment of the present invention, the above-mentioned both features for long distance and short distance can be implemented in the mobile communication terminal or one of features for long distance and short distance can be individually implemented in the mobile communication terminal as described in FIGS. 2 and 3. In the case of implementing both features into the mobile communication terminal, when remote control signals are inputted by a user to a mobile communication terminal through the input device 17, a list of short-range mobile communication address is searched for an of the remote mobile communication terminal. And the list of short-range mobile communication address is updated periodically. Examples of such address herein include phone numbers.

If the address is in the list of short-range mobile communication address, a set of procedures described below in FIG. 3 is performed. If the address is not included, a set of procedures described below in FIG. 2 is performed. Here, the address of the remote mobile communication terminal can be either entered directly through the input device 17 or transmitted in the form of remote control request signals carrying address information. Therefore, each mobile communication terminal needs to store the list of short-range mobile communication address for mobile communication terminals forming a Piconet (PAN). The Piconet (PAN) is formed when two or more mobile communication terminals communicate each others based on Bluetooth technology.

FIG. 2 is a flowchart for explaining a method for remotely controlling a mobile communication terminal from a long distance in accordance with an embodiment of the present invention.

Firstly, at step S201, the operation/control device 12 of a mobile communication terminal establishes a call connection with a remote mobile communication terminal according to a remote control request signal inputted through the input device 17 from the user. After establishing the mobile communication call connection, an authentication procedure is performed by the remote mobile communication terminal to authorize gaining control of the remote mobile communication terminal from a distance. Here, the authentication procedure to authorize gaining control of the remote mobile communication terminal from a distance involves the use of either the address, e.g., phone number, of the user's terminal or a password entered directly through the input device 17 by a user.

At step S202, the operation/control device 12 accepts remote control signals and, at step S203, transmits the remote control signals to the remote mobile communication terminal through a mobile communication network. The remote control signal may include various control signals for receiving and sending out data such as pictures, photographs, music and multimedia data, searching through an electronic address book or updating an entry in the e-book, enabling a built-in digital camera to take a picture and such like. The user can select desired control signal by using a menu selection function in the mobile communication terminal. Based on the remote control signals, the user can select desired operation of the remote mobile communication terminal such as receiving and sending out data such as pictures, photographs, music and multimedia data, searching through an electronic address book or updating an entry in the e-book, enabling a built-in digital camera to take a picture and such like.

On the other hand, at step S204, the operation/control device 12 of the remote mobile communication terminal performs corresponding operations according to the received remote control signal from the mobile communication terminal. Then, the operation/control device 12 of the remote mobile communication terminal transmits the result of the corresponding operations performed. At step S205, the operation/control device 12 of the mobile communication terminal displays the result from the remote mobile communication terminal on the display device 16 as a result of remote control. After step S205, a sequence of steps from S202 to S205 repeats until the operation/control device 12 picks up a call sign-off signal at step S206.

FIG. 3 is another flowchart showing a method for controlling a mobile communication terminal from a short distance in accordance with an embodiment of the present invention.

Firstly, at step S301, the operation/control device 12 of a mobile communication terminal establishes a communication link with a remote mobile communication terminal from a short distance using a Bluetooth communication based on information contained in a remote control request signal generated by a user via the input device 17 and thereby gaining control of the remote mobile communication terminal from a short distance. The brief description of a connection procedure used in Bluetooth protocol is given as follows.

A communication based on the Bluetooth technology is a mater-slave type communication. Time-sharing is used for communication between a plurality of slaves and the mater in the Bluetooth communication. That is, a communication time is divided based on the timeslots, which are 625 micro-seconds in duration and each timeslot is allocated to the master and slaves according to a predetermined rule. That is, the master uses even-numbered slots and slaves use odd-numbered slots in the Bluetooth communication. Here, the master can communicate with 7 other slaves at once in the time-sharing communication type. An active member address 1 to 7 is allocated to each of 1^{st} to 7^{th} slaves. The Active Member ADDRess (AM_ADDR) is 3 bits long, raging from 1 to 7 on a one-on-one basis.

The Active Member ADDRess (AM_ADDR) is an address allocated to slave Bluetooth device by the master to distinguish each Bluetooth device in a Piconet (PAN). The Piconet is a set of device using same channel for communicating each others. Following from the above, two or more Bluetooth devices sharing identical channel forms the Piconet (PAN). One of the Bluetooth devices is selected as the master for controlling traffic on the channel and remained Bluetooth devices become slaves.

In accordance with a preferred embodiment of the present invention, a mobile communication terminal of the user becomes a master terminal and the remote mobile communication terminal to be controlled from a distance by the user becomes a slave terminal.

The master terminal periodically listens for messages based on a set of 32 hop frequencies defined therein. Here, a communication link between the master and the slave is established by a page message forwarding, if the address of the slave terminal is known. If the address of the slave terminal is not known, an inquiry message is forwarded to establish the communication link and the communication link is established by a page message forwarding. In other words, when the slave terminal receives the inquiry message, the slave terminal transmits a packet containing information on the clock and the address of a Bluetooth device installed therein. Then, the transmission of data is enabled at the same time as the master terminal accepts the packet forwarded by the slave.

After the step S301, when the communication link is established according to the Bluetooth protocol, an operation/control device 12 of the master terminal received a remote control signal inputted through the input unit 17 from the user at step S302. After receiving the remote control signal, the operation/control device 12 of the master terminal transmits the remote control signals to the remote mobile communication terminal using Bluetooth technology at step S303. On the other hand, at step S304, an operation/control device 12 of the remote mobile communication terminal performs corresponding operations according to the remote control signals and then passes the result of the corresponding operations to the master terminal. Then, the operation/control device 12 of the master terminal displays the result on the display device 16 at step S305. From this step on, a sequence of steps from step S302 to step S305 repeats until the operation/control device 12 picks up a call sign-off signal at step S306.

As mentioned above, by remotely controlling the mobile communication terminal from a distance, a user can easily download data from a desired mobile communication terminal and therefore, the present invention increases convenience of user of the mobile terminal.

While the present invention has been described with respect to certain preferred embodiments, it will be apparent to those skilled in the art that various changes and modifications may be made without departing from the scope of the invention as defined in the following claims.

1. A method for remotely controlling a mobile communication terminal from a distance, the method comprising the steps of:
a) determining whether or not an address of a remote mobile communication terminal is included in a list of short-range mobile communication address according to a remote control request signal;
b) if the address of the remote mobile communication terminal is included in the list of short-range mobile communication address, controlling the remote mobile communication terminal according to a remote control signal inputted through an input unit by establishing a communication link with the remote mobile communication terminal from a short distance using a Bluetooth protocol according to the remote control request signal, authorizing a remote control of a remote wireless communication terminal; and
c) if the address of the remote mobile communication terminal is not included in the list of short-range mobile communication address, controlling the remote mobile communication terminal according to a remote control signal inputted through an input unit by establishing a call connection between the mobile communication terminal and the remote mobile communication terminal according to a remote control request signal and authorizing a remote control of the remote mobile communication terminal.

2. The method as recited in claim 1, wherein the step b) includes the steps of:
b1) establishing a communication link with a remote mobile communication terminal using a Bluetooth protocol and authorizing a remote control of a remote wireless communication;
b2) receiving a remote control signal inputted by a user through an input unit and transmitting the remote control signal to the remote mobile communication terminal using a Bluetooth device;
b3) performing corresponding operations according to the remote control signal and transmitting result of corresponding operations to the mobile communication terminal by using the Bluetooth device; and
b4) displaying the result from the remote mobile communication terminal on a display unit as a result of remote control.

3. The method as recited in claim 1, wherein the step c) includes the steps of:
c1) establishing a call connection between a mobile communication terminal and a remote mobile communication terminal according to a remote control request signal and authorizing a remote control of the remote mobile communication terminal;
c2) receiving a remote control signal inputted through an input unit and transmitting the remote control signal to the remote mobile communication terminal;
c3) performing corresponding operations according to the remote control signal and transmitting result of corresponding operations to the mobile communication terminal; and
c4) displaying the result from the remote mobile communication terminal on a display unit as a result of remote control.

4. The method as recited in claim 1, wherein in the step a), a phone number of the mobile communication terminal is used as the address.

5. The method as recited in claim 1, wherein in the step a), a password of the mobile communication terminal inputted by a user is used as the address.

6. A mobile communication terminal for remotely controlling other mobile communication terminal, comprising:
a memory for storing a list of short-range mobile communication address;
a controller for determining whether or not an address of a remote mobile communication terminal is included in the list of short-range mobile communication address according to a remote control request signal;
a mobile communication transceiver for communicating a remote mobile communication terminal through a mobile communication network by establishing a call connection with the remote mobile communication terminal according to the remote control request signal and authorizing a remote control of the remote mobile communication terminal when a result of the determination of the controller is that the address of a remote mobile communication terminal is not included in the list of short-range mobile communication address; and
a Bluetooth communication transceiver for communicating a remote mobile communication terminal through Bluetooth communication by establishing a communication link with the remote mobile communication terminal and authorizing the remote control of the remote communication mobile terminal when a result of determination of the controller is that the address of the remote mobile communication terminal is not included in the list of short-range mobile communication address.

7. The method as recited in claim 1, wherein the list of short-range mobile address is periodically updated.
